(19) United States
(12) Patent Application Publication
(10) Pub. No.: US 2014/0352578 A1
(43) Pub. Date: Dec. 4, 2014

(54) Compositions and Methods For Making of a Concrete-Like Material Containing Cellulosic Derivatives

(71) Applicant: Mason Baker, Oxford, MI (US)

(72) Inventor: Mason Baker, Oxford, MI (US)

(73) Assignee: SANDROCK VENTURES LLC, Oxford, MS (US)

(21) Appl. No.: 14/292,468

(22) Filed: May 30, 2014

Related U.S. Application Data
(60) Provisional application No. 61/829,787, filed on May 31, 2013.

(51) Int. Cl. C04B 18/24; C04B 18/26; C04B 28/04

(52) U.S. Cl. CPC C04B 18/24; C04B 28/04; C04B 18/26; C04B 18/248
USPC 106/731; 106/805; 536/56

(57) ABSTRACT

A composition includes an admixture of a cementitious component and a cellulosic component. The cellulosic component includes a cellulosic fibrous material and water. The admixture is suitable for mixing with a second amount of water to form a hardened material. A method includes reducing a cellulosic fiber material to produce a fiber fragment material, treating the fiber fragment material, and rinsing the treated fiber fragment product with water to form a rinsed fiber fragment material. Treating the fiber fragment material includes admixing the fiber fragment material and water to form an admixture, heating the admixture, agitating the admixture, and separating a treated fiber fragment product from the admixture. The method is effectively controlled so that the rinsed fiber fragment material is suitable for reacting with a cementitious component to form a hardened material.

### CROSS-REFERENCE TO RELATED APPLICATION

This is related to and claims priority from co-pending U.S. Provisional Application for Patent No. 61/829,787 which was filed on May 31, 2013.

### FIELD OF THE INVENTION

The invention relates to compositions that are cementitious-type material, and methods of making such compositions. More particularly, the invention relates to cementitious materials having reactants therein derived from cellulosic matter that can be used in the composition in place of gravel, sand, and other additives typical for concrete.

### BACKGROUND OF THE INVENTION

Concrete and other material produced from cementitious-based components are the ubiquitous material used in the construction industry. The versatility of such material is that it can be prepared prior to the construction process or as a part of it. Among the features sought in such material are flowability prior to hardening to facilitate placement, compressive or flexural strength in its final state, weight of material, capability to integrate additives that provide additional characteristics, cost and availability of components, porosity of formed material, handling of formed material, and suitability to perform additional construction processes with it.

Concrete typically is a conglomerate of aggregate material embedded in a matrix of either mortar or cement, which sets to a hard, infusible solid on standing either by hydraulic action or by chemical cross-linking. Examples of aggregate materials are gravel, pebbles, sand, broken stone, blast-furnace slag, cinders, and the like. Examples of mortar are materials made with cement, lime, silica, sulfur, and sodium or potassium silicate, and the like.

Typical of cements is the standard Portland cement, which is a type of hydraulic cement in the form of finely divided, gray powder composed of lime, alumina, silica, and iron oxide as tetracalcium aluminoferrate, tricalcium aluminate, tricalcium silicate, and dicalcium silicate. Hydraulic cement will set by admixture with water, which combines chemically to form a hydrate. Additives may also be present to improve adhesion, strength, flexibility, and curing properties. Hardening does not require air and can occur under ater. Water evaporation can be retarded by adding such resins as methylcellulose and hydroxyethylcellulose.

A particular function of aggregate in concrete is to bring strength to the hardened concrete and early resistance to flow while the hardening process is occurring. It can also function as a simple filler to reduce the cement values.

Attempts to bring innovation to the concrete-based technologies and related cement industries have included efforts to find a use for fibrous materials as an additive or as a substitute for aggregate. The fibrous materials have included both organic and inorganic fibers and both natural and man-made fibers.

For example, the use of cellulosic material as a filler or extender for hydraulic cement compositions is known. However, cellulose fiber cement materials can have performance drawbacks, such as lower resistance to water-induced damage, higher water permeability, higher water migration ability (also known as wicking), and lower freeze thaw resistance when compared to asbestos cement composite material. These drawbacks are largely due to the presence of water-conducting channels and voids in the cellulose fiber lumens and cell walls. The pore spaces in the cellulose fibers can become filled with water when the material is submerged or exposed to rain/condensation for an extended period of time. The porosity of cellulose fibers facilitates water transportation throughout the composite materials and can affect the long-term durability and performance of the material in certain environments. As such, conventional cellulose fibers can cause the material to have a higher saturated mass, poor wet-to-dry dimensional stability, lower saturated strength, and decreased resistance to water damage.

The high water-permeability of the cellulose-reinforced cement materials also results in potentially far greater transport of some soluble components within the product. These components can then re-deposit on drying, either externally, causing efflorescence, or internally, in capillary pores of the matrix or fiber. Because the materials are easier to saturate with water, the products also are far more susceptible to freeze/thaw damage. However, for vertical products, or eaves and soffit linings, and for internal linings, none of these water-induced disadvantages is very relevant.

It is also known to graft a silyating agent to the fiber surface so as to improve the strength of the resulting composite material. The silyating agent can include molecules containing hydrophilic groups on both ends so that one end can bond with hydroxyl groups on the fiber surface and the other end can bond with the cementitious matrix. The silyating agent essentially serves as a coupling agent that connects hydroxyl groups on the fiber surface to the cementitious matrix.

A chelating agent can be applied to a cellulose fiber to reduce fiber swelling in aqueous and alkaline solutions. For example, the fibers can be impregnated with a solution of a titanium and/or zirconium chelate compound. The chelate compound, however, does not react upon contact with the fiber, because the fiber is contained in an aqueous medium, and chelate compounds resist hydrolysis at ambient temperatures. However, because this solution is directed primarily to reducing swelling of cellulose fibers, it is not specifically directed to increasing hydrophobicity of the fibers. Moreover, this approach to fiber treatment requires drying of the fibers in order to induce reaction with the cellulose fibers.

Cellulose fibers can also be chemically treated to impart the fibers with hydrophobicity and/or durability, and to make cellulose fiber-reinforced cement composite materials using these chemically-treated cellulose fibers. For example, the cellulose fibers can be treated or sized with specialty chemicals that impart the fibers with higher hydrophobicity by partially or completely blocking the hydrophilic groups of the fibers. Alternatively, the fibers can be chemically treated, including by loading or filling the void spaces of the fibers with insoluble substances, or treating the fibers with a biocide to prevent microorganism growth, or treating the fibers to remove the impurities, and perform other functions.

There remains a need for a cement-derived material that can incorporate fibrous material. In particular, there is a need for such a material that can allow the reduction of the aggregate content while maintaining or improving the properties of the material, such as compressive or flexural strength.

### BRIEF SUMMARY OF THE INVENTION

The present invention allows the substitution in whole or in part of the aggregate and sand content of concrete and similar material with another material without loss of associated properties. Unexpectedly, there are significant improvements of some of the properties, as hereinafter described.

According to the present invention, a material is provided that can be used in place of and instead of concrete, mortar, and similar cementitious-type materials presently used in the construction and other industries, without loss of strength or other favorable properties.

According to the present invention, a concrete-like or cementitious-like material is provided having one or more of the following characteristics:
high compressive strength;
high early compressive and flexural strength with or without accelerated curing or fast cements;
ductility, particularly with high flexural strengths;
working characteristics similar to wood in being nailable, screwable, and cuttable using tools with which to do the same work with wood;
machinability, such as being susceptible to turning screw threads and hand tapping;
fireproof;
termite and dry-rot proof;
lightweight, even buoyant in water;
thermal insulating; and
negligible shrinkage in drying.

These and other objects are achievable in the practice of the present invention herein. Unexpectedly, many of the properties of the current invention not only match, but favorably exceed that of standard concrete.

According to an aspect of the invention, a composition includes an admixture of one or more cementitious component(s) and one or more cellulosic component(s). The one or more cellulosic component(s) include one or more cellulosic fibrous material(s) having a defined size and a defined aspect ratio, and a first amount of water associated with the cellulosic fibrous material(s). The admixture is suitable for mixing with a second amount of water to form a hardened product. The defined size, the defined aspect ratio, and the first and second amounts of water are effectively controlled such that the hardened product has a compression test value of at least about 2,500 pounds of pressure per square inch as measured within seven days.

A hardened product can include a composition as described above and the second amount of water. In this case, the admixture and the second amount of water have reacted to form a hardened state.

The cementitious component can include a mortar, a hydraulic cement, a Portland cement, supplementary cementitious materials, and/or an accelerant.

The cellulosic fibrous material can be derived from a woody plant. For example, the cellulosic fibrous material can be a wood chip and/or wood pulp.

The cellulosic fibrous material can be derived from a non-woody plant, or from bagasse.

The cellulosic fibrous material can be derived from a cellulosic hull, such as a cotton hull, a grain hull, coffee hull, and/or a nut hull.

The cellulosic hull can be a grain hull, such as a rice hull.

The cellulosic fibrous material can have a length in a range of about 0.1 centimeters to about 2.0 centimeters, or more particularly in a range of about 0.5 centimeters to about 1.0 centimeters.

The cellulosic fibrous material can have an aspect ratio in a range of about 1.0 to about 0.05.

The cellulosic fibrous material can have a particle size distribution with controlled head and tail portions.

The first amount of water can be included in an amount from about 20 percent to about 40 percent, as measured by a weight of the first amount of water to a weight of the first amount of water and the cellulosic fibrous material combined.

The cellulosic fibrous material can include rice husks, and the weight ratio of cementitious component to cellulosic component can be in the range of about 6 to about 110. The cementitious component can include cement, and can also include sand. The weight ratio of cement to sand can be, for example, in the range of about 1.2 to about 2.4.

According to another aspect of the invention, a composition includes an admixture of one or more cementitious component(s), and one or more cellulosic component(s). The one or more cellulosic component(s) include one or more cellulosic fibrous material(s) having a defined size and a defined aspect ratio, and a first amount of water associated with said cellulosic fibrous material. The admixture is suitable for mixing with a second amount of water to form a hardened product. The defined size, the defined aspect ratio, and the first and second amounts of water are effectively controlled such that the hardened product has a product compression test value greater than a comparison compression test value of a comparison hardened product comprising equivalent amounts of the cementitious component, the first and second amounts of water, and a volume of sand and aggregate equal to the volume of the cellulosic material. For example, the product compression test value can be at least about ten percent greater than the comparison compression test value, preferably twenty-five percent greater, and more preferably about two hundred percent greater than said comparison compression test value.

The defined size, the defined aspect ratio, and the first and second amounts of water can be effectively controlled such that the hardened product has a weight of at most about 75% of a weight of the comparative hardened product.

The defined size, the defined aspect ratio, and the first and second amounts of water can be effectively controlled such that the hardened product has a porosity of at most about 75% of a porosity of the comparative hardened product.

The defined size, the defined aspect ratio, and the first and second amounts of water can be effectively controlled such that the hardened product has a weight of at most about 75% of a weight of the comparative hardened product, a porosity of at most about 75% of a porosity of the comparative hardened product, and a compaction test value of at least 50% greater than a compaction test value of the comparative hardened product.

According to another aspect of the invention, a method includes reducing a cellulosic fiber material to produce a fiber fragment product, admixing the fiber fragment product and water to form an admixture, heating the admixture, agitating the admixture, separating a treated fiber fragment product from the admixture, and rinsing the treated fiber fragment product with water to form a rinsed fiber fragment product. The method is effectively controlled so that the rinsed fiber fragment product is suitable for reacting with a cementitious composition to form a product having a compressive strength at least equal to about 2,500 pounds of pressure per square inch after seven days.

The method can also include acid-treating said admixture.

The method can also include creating an admixture of the rinsed fiber fragment product, a cementitious binder, and water, and mixing the admixture to produce a mixed mass. The method can also include reacting the mixed mass to create a product including reacted rinsed fiber fragment product and cementitious binder.

Rice husks contain tannic acid, which can affect concrete strength. However, the tannic acid is only present in the rice husks to the extent that it would cause a negligible effect on the finished product. Therefore, boiling the rice husks and cleaning them of tannic acid prior to proceeding prior to processing can be performed if desired, but is not necessary. Further, the rice husks can be cut down in size if it suits the particular application. However, in general, cutting the husks has no significant effect on the finished product and need not take place.

Preferably, the use of calcium chloride as an additive is not acceptable for use in the US due to the detriment to the reinforcing steel, inbeds, post-tensioning cables, etc. However, in applications in which cooperating elements are not affected by its use, calcium chloride can be included as an ingredient in a manner known to those of skill in the art.

According to another aspect of the invention, a composition includes an admixture of at least one cementitious component and at least one cellulosic component. The at least one cellulosic component includes at least one cellulosic fibrous material and a first amount of water associated with the at least one cellulosic fibrous material. The at least one cellulosic fibrous material has a length of about 0.1 centimeters to about 2.0 centimeters and an aspect ratio of about 1.0 to about 0.05. The first amount of water associated with the at least one cellulosic fibrous material is included in a range of from about 20 percent to about 40 percent, as measured by weight of water to weight of water and the at least one cellulosic fibrous material combined. The amount of the at least one cementitious component is included in a range of about nine times to about eleven times by weight compared to the amount of included cellulosic component. The admixture is suitable for mixing with a second amount of water to form a hardened material.

The composition can also include a quantity of corrosion inhibitor, such as DCI-S.

The cementitious component can include a mortar, a gravel, a sand, and/or an accelerant.

The cementitious component can include a hydraulic cement, such as a Portland cement. For example, the Portland cement can be a 42.5 grade Portland cement.

The cellulosic fibrous material can be woody plant material, such as wood chip or wood pulp.

The cellulosic fibrous material can be non-woody plant material, bagasse material, and/or cellulosic hull material. For example, the cellulosic fibrous material can be extracted from a cellulosic hull such as a cotton hull, a grain hull, and/or a nut hull. The cellulosic hull can be a grain hull, such as a rice hull, and the cellulosic fibrous material can be processed rice hull fibers.

The cellulosic fibrous material can have a length in a range of about 0.5 centimeters to about 1.0 centimeters.

The cellulosic fibrous material can have a particle size distribution with controlled head and tail portions.

The cementitious component can be Portland cement included in a range of about 78 parts to about 80 parts, and the cellulosic component can be rice hull fibers included in a range of about 7 parts to about 9 parts.

According to another aspect of the invention, a flowable material includes the composition described above, and a second amount of water, included in a range of about 90 fluid ounces to about 110 fluid ounces per part.

According to another aspect of the invention, a flowable material includes the composition described above, and a second amount of water, included in a range of about 90 percent to about 110 percent, as measured by weight of water to weight of cellulosic fibrous material.

According to another aspect of the invention, a hardened material includes the composition described above, having a compression test value of at least about 2,000 pounds of pressure per square inch.

According to another aspect of the invention, a method includes reducing a cellulosic fiber material to produce a fiber fragment material, treating the fiber fragment material, and rinsing the treated fiber fragment product with water to form a rinsed fiber fragment material. Treating the fiber fragment material includes admixing the fiber fragment material and a quantity of water to form an admixture, heating the admixture, agitating the admixture, and separating a treated fiber fragment product from the admixture. The quantity of water falls in a range of from about 20 percent to about 40 percent, as measured by weight of water to weight of water and the fiber fragment material combined. The method is effectively controlled so that the rinsed fiber fragment material is suitable for reacting with a cementitious component to form a hardened material.

The fiber fragment material can have a length of about 0.1 centimeters to about 2.0 centimeters and an aspect ratio of about 1.0 to about 0.05.

The method can also include acid-treating the admixture.

The method can also include admixing the rinsed fiber fragment material, a cementitious binder, and water, and mixing the admixture to produce a mixed mass. The cementitious binder can be, for example, Portland cement included in a range of about 78 parts to about 80 parts, and the cellulosic fiber material can be rice hull fibers included in a range of about 7 parts to about 9 parts. The water can be included in a range of about 90 fluid ounces to about 110 fluid ounces per part.

Mixing the admixture can include mixing the admixture using a twin-shaft mixer. The mixing paddles and shanks of the mixer can be mounted on timed driving shafts, in equally-spaced rows, opposing each other and counter-rotating during operation. The mixing paddles can be disposed at angles of 90 degrees and 45 degrees from a center line of the driving shafts, such that each shaft has alternating rows of 45-degree paddles in opposition to alternating rows of 90-degree paddles.

The method can include reacting the mixed mass to create a hardened material including reacted rinsed fiber fragment material and the cementitious binder.

The method can include admixing at least one cementitious component and the rinsed fiber fragment material. The amount of the at least one cementitious component can be included in a range of about nine times to about eleven times by weight compared to the amount of included rinsed fiber fragment material, and the composition can be suitable for mixing with a second amount of water to form a hardened material.

### BRIEF DESCRIPTION OF THE DRAWING

Depicted in the accompanying drawing FIGURE is a flowchart of an exemplary method of making the compositions of the present invention.

### DETAILED DESCRIPTION OF THE INVENTION

One embodiment of the present invention is a composition including an admixture of a cementitious component and a cellulosic component. The cellulosic fibrous material has a defined size and a defined aspect ratio. A controlled amount of water associated with the cellulosic fibrous material, as described hereinafter in detail. This water content is defined separately from the amount of water added to instigate the reaction of materials in the composition to form a hardened product with the admixture.

The cementitious material can be that typically used in the concrete, mortar, cement and related cement-derived material industry. The cementitious component preferably is a mortar or a hydraulic cement, more preferably a Portland cement. The cementitious component may also contain additional components, such as an optional accelerant to assist in the hardening process. As described hereinafter, such additional components are not necessarily needed for a variety of the compositions and of the applications.

The cellulosic material can be that generally containing a natural carbohydrate high polymer (polysaccharide) consisting of anhydroglucose units joined by an oxygen linkage to form essentially linear, long molecular chains. The degree of polymerization can range from 1000, as in wood, to 3500, as in cotton fiber, and typically have a molecular weight from 160,000 to 560,000. Typical sources are wood, paper, pulp, cotton products, biomasses, and plant portions, such as grain hulls, preferably exemplified by rice.

Generally speaking, the cellulosic fibrous material may be prepared from cellulose fibers from synthetic sources or sources such as woody and non-woody plants. Woody plants include, for example, deciduous and coniferous trees. Non-woody plants include, for example, cotton, flax, kenaf, and certain grass, milkweed, straw, jute, hemp, and bagasse. The cellulose fibers may be modified by various treatments such as, for example, thermal, chemical and/or mechanical treatments. It is contemplated that reconstituted and/or synthetic cellulose fibers may be used and/or blended with other cellulose fibers of the cellulosic fibrous material. Cellulosic fibrous materials may also be composite materials containing cellulosic fibers and one or more non-cellulosic fibers and/or filaments. A synthetic source example is recycled paper.

Preferred sources of cellulosic material are sugar canes, corn husks, wood chips and wood pulps.

Other preferred sources of cellulosic fibrous materials are cellulosic hulls. Preferred hulls are cotton hulls, grain hulls, nut hulls, coffee hulls, and rice hulls.

According to an aspect of the invention, the transport phenomenon occurs during the hydration reaction of the cementitious material, which also involves a reaction between the composition chemicals of the cementitious materials and that of the cellulosic fiber or fiber fragment. The range of the fiber moisture is believed critical in that the fibers must be sufficiently moist to prevent too much water absorption during the hydration process from the fiber into the adjacent cementitious material, and also not too wet to prevent the bonding/reacting of the fiber material and cementitious material, allowing transport of material onto and into the fiber material for reactions. Observation of the hardened material of the present invention can allow one description of the interface of the fiber-cementitious material bond as being analogous to the weld zone observed in metallic welds. This differs from the encasement or encapsulation of fiber materials which can often be viewed in conventional fibrous cement compositions. Also a factor is the size and shape of the cellulosic fibrous material, such having impact not only on the chemical reactions during hardening but also on the resulting strength and other performance parameters of the hardening and hardened product. This theory is not exclusive as other physical and chemical phenomena may also occur as well.

One embodiment of the present invention is a composition including an admixture of one or more cementitious component(s) and one or more cellulosic component(s). The cellulosic components include one or more cellulosic fibrous material(s) having a defined size and a defined aspect ratio, and a first amount of water associated with the cellulosic fibrous material(s).

The admixture is suitable for mixing with a second amount of water to form a hardened product.

According to preferred embodiment, the defined size, defined aspect ratio and the first and second amounts of water are effectively controlled such that the hardened product has a compression test value of at least about 2,500, more preferably at least about 3,300, pounds of pressure per square inch as measured within seven days.

In one embodiment of the present invention, the cellulosic fibrous material has a preferred length of about 0.1 centimeters to about 2.0 centimeters, more preferably about 0.5 centimeters to about 1.0 centimeters. Even longer or shorter lengths are useable, but the shorter values generally are to be favored initially.

In yet another embodiment of the present invention, the cellulosic fibrous material has an aspect ratio of about 1.0 to about 0.05.

In yet another embodiment of the present invention, the cellulosic fibrous material has a particle size distribution with controlled head and tail portions. These portions can be screened in accordance with their impact on the performance of the composition.

In yet another embodiment of the present invention, the water associated with the cellulosic fibrous material is from about 20 percent to about 45 percent, more preferably about 35 percent to about 40 percent, as measured by weight of water to weight of water and cellulosic fibrous material combined. The specific amount will vary according to conditions of the materials used and other factors discussed herein, and may be determined by consideration of material testing on the intermediate product or on the final hardened product, such as compression test and other similar tests.

In yet another embodiment, the present invention is a composition including the hardened product of the admixture after the reaction between the cement portion and the cellulosic portion.

In yet another embodiment of the present invention, the composition includes an admixture of one or more cementitious component and one or more cellulosic component. The cellulosic component includes one or more cellulosic fibrous material(s) having a defined size and a defined aspect ratio, and a first amount of water associated with the cellulosic fibrous material. The formed admixture is suitable for mixing with a second amount of water to form a hardened product. The defined size, defined aspect ratio, and the first and second amounts of water are effectively controlled such that the hardened product has a compression test value greater than that of a comparison composition including equivalent amounts of the cementitious component.

According to preferred embodiment of the present invention, the composition just described has a compression test value at least about ten percent greater, more preferably at least about twenty-five percent greater, and under certain parameters as great as 200 percent greater than of the comparison composition.

According to another preferred embodiment in the composition just described, the defined size, defined aspect ratio, and the first and second amounts of water are effectively controlled such that the hardened product has a weight of at most about 75% of the comparative composition. In some embodiments, such as those wherein the cellulosic material is about 50% of the weight of the total admixture, the final hardened product is buoyant.

In yet another embodiment the defined size, defined aspect ratio, and the first and second amounts of water are effectively controlled such that the hardened product has a porosity of at most about 75% of the comparative composition.

According to an exemplary embodiment, the defined size, the defined aspect ratio, and the first and second amounts of water are effectively controlled such that the hardened product has a weight of at most about 75% of the comparative composition, a porosity of at most about 75% of the comparative composition, and a compaction test value of at least 50% greater than that of the comparative composition.

According to another exemplary embodiment, the present invention is a method according to which preparation includes reduction of a cellulosic fiber material to produce a fiber fragment product. Treatment includes admixing the fiber fragment product and water to form an admixture, heating the admixture, agitating the admixture, optionally acid-treating the admixture, and separating a treated fiber fragment product from the admixture. The treated fiber fragment product is rinsed with water to form a rinsed fiber fragment product.

It is understood that the heating of the admixture can be reduced or eliminated and the water can be first heated prior to admixing.

According to an exemplary embodiment, the method is effectively controlled so that the rinsed fiber fragment product is suitable for reacting with a cementitious composition to form a product having a compressive strength at least equal to about 2,500, and more preferably about 3,300, pounds per square inch after seven days.

The accompanying FIGURE depicts a flow chart of an exemplary embodiment of the invention. It is to be appreciated that the depicted method illustrates not only the making of the inventive composition of treated fiber material, but also a method of the production of a cementitious material incorporating such treated fiber material.

In the FIGURE, five stages of operations are depicted, namely, fiber preparation, fiber treatment, fiber rinse, moisture adjustment, and components mixing. It is noted that the stages of fiber treatment, fiber rinse and moisture adjustment may be performed using the same equipment or separate equipment and during overlapping times of operation.

In the fiber preparation stage, a cellulose-containing material is subjected to grinding to break down the superficial structure and to perform some amount of defibrillation, if possible. As a non-limiting example, rice hull can be subjected to grinding using a conveniently available machine to reduce the rice hull into fragments of less than one-half of an inch, preferably less than one-eighth of an inch. The fragments are then provided to the fiber treatment stage.

In the fiber treatment stage, the fiber fragments are subject to agitation in water. The desired result is cleaning of the fiber fragment of debris which can interfere with the fiber fragment reaction with cement. Preferably, the water is heated, with a high temperature approaching boiling being preferred. To assist in the treatment, an acidic component, as derived, for example, according to the method described in U.S. Pat. No. 5,433,272, may be added, which helps to clean the fragments or facilitate fragmentation. After treatment, the excess fluids are drained through filters and the treated fiber fragments are provided the fiber rinse stage.

In the fiber rinse stage, the treated fiber fragments are rinsed with water in a batch or continuous manner to further remove debris from the fragments. One or more rinse cycles may be necessary to achieve a fiber fragment that will perform to the desired specification in the compositions. The fragments are then processed further in the moisture adjustment stage.

In the moisture adjustment stage, the fiber is analyzed for moisture content and it is determined whether the moisture content is satisfactory or in need of adjustment. The determination to make adjustments can be based, at least in part, upon the performance of the composition achieved after mixing with cement in the intended application. This can be based, for example, on either pre-existing specifications that set the moisture content range or on data in the field providing performance feed-back indicating the need for moisture adjustment. Naturally, moisture content may be varied depending upon the fiber-type selection or mix, degree of grinding, fiber batch performance, ambient humidity and temperatures, and cement type. Other considerations may also be made, such as standing time, additional additives to the mix, and the like. As discussed elsewhere, the moisture content of the treated fiber fragment is controlled to achieve the intended reaction results with the cement that is used.

After any moisture adjustments, the fiber fragments are then subjected to the components admixing stage, in which the cement or cement-like reactant is admixed with the treated fiber fragments and appropriate amounts of water and additives, if any, to induce the start of the hardening process. The method of and energy applied to the admixing stage can vary according to the desires of the application. Naturally, the fiber moisture should be preserved until admixing occurs or any changes in moisture content anticipated and adjusted for in the moisture adjustment stage.

For instance, mixing can be performed in a fixed equipment operation and the produced cementitious product provided to an application. One non-limiting example would be in a manufacturing facility in which the cementitious material is cast for production of a product, such as siding for a house or a railroad tie.

According to another illustrative example, the mixing can be performed in a typical concrete mixer truck in which mixing occurs before, during, or after transportation to a pour site for application of the admixture.

Other mixing equipment can be used, such as high speed centrifugal mixers, for example. One advantage of the present inventive composition is that it can be substituted in place of conventional concrete not only in use but in the equipment used to apply concrete.

According to yet another embodiment, the present invention can also include a mixing operation, including creating an admixture of the rinsed fiber fragment product, a cementitious binder, and water, and mixing the admixture to produce a mixed mass.

Optionally, this method can then be extended to include sequentially reacting the mixed mass to create a product including reacted rinsed fiber fragment product and cementitious binder.

Various embodiments of the present invention are described according to the following examples.

### Example 1

Cylinder strength tests were performed on compositions of materials made in accordance with the present invention. The materials were formed into cylinders of 4 inches in diameter and 8 inches in length and tested on a Service Physical Tester, Model PCHD 250 Concrete Tester. The following results were obtained:

First Composition Test Series

| | Cylinder Age | Total Load |
|---|---|---|
| Sample Number | (Days) | (Pounds) |
| 1-1 | 6 | 42,500 |
| 1-2 | 6 | 44,500 |
| 1-3 | 6 | 48,500 |
| 1-4 | 6 | 45,000 |
| 1-5 | 28 | 49,000 |

Second Composition Test Series

| Sample | Cylinder Age | Total Load |
|---|---|---|
| Number | (Days) | (Pounds) |
| 2-1 | 7 | 46,000 |
| 2-2 | 7 | 39,500 |
| 2-3 | 8 | 71,500 |
| 2-4 | 9 | 30,000 |
| 2-5 | 9 | 47,500 |
| 2-6 | 9 | 23,000 |
| 2-7 | 9 | 53,500 |

Third Composition Test Series

| Sample | Cylinder Age | Total Load |
|---|---|---|
| Number | (Days) | (Pounds) |
| 3-1A | 7 | 45,500 |
| 3-1B | 7 | 52,000 |
| 3-1 | 14 | 64,000 |
| 3-1 | 28 | 60,500 |
| 3-2A | 7 | 52,000 |
| 3-2B | 7 | 55,000 |
| 3-2 | 14 | 58,000 |
| 3-2 | 28 | 62,000 |

It is to be noted that Sample 2-2 was made with a weight proportion of about 7.5 pounds cement to 3.2 pounds of wet fiber and 78 ounces of water added to make the sample. It is further noted that Sample 2-3 was made with a proportion of 2 volume units of cement to 1 volume unit of inventive fiber at 45% moisture by weight. The remaining samples were generally about 5 volume units of cement to 1 volume unit of fiber. The attained results were achieved by varying the fluids in the fiber prior to mixing with the cement and varying the amount of water added to the mixture of fiber and cement and are provided here to exemplify the general nature of such achievable results.

### Example 2

Two samples of the inventive composition, A and B respectively, were made using the following formulation for each cubic yard of sample:

| | |
|---|---|
| 10 bags cement | 940 pounds |
| Water | 480 pounds |
| Inventive treated fiber | 240 pounds |

Sample A was mixed in a typical truck barrel mixer as used in conventional “ready mix” operations. Sample B was mixed in a high speed vertical mixer at a rotation speed of about 3,000 to 6,000 revolutions per minute for a similar length of time.

A standard compression test after 30 days as for a concrete test cylinder produced the following results:

| Sample | Compression Strength (psi) |
|---|---|
| A | 5,000 to 7,000 |
| B | 7,000 to 12,000 |

Rice husk ash has been shown to perform well as a supplementary cementitious material. However, the use of unburned, rice husks in concrete is a novel idea. Rice husks are one of the world's most abundant renewable waste resources. Approximately 130 million tons of rice husks are produced annually. Thus, using rice husks as a component of concrete is would beneficially make use of a readily available waste material.

To qualify a raw material for use in concrete, three key material properties must be identified: 1) the bulk specific gravity of the material, 2) a particle size distribution of the material, and 3) water absorption rates of the material. The bulk specific gravity provides an idea of how much volume will be taken up by the material in a concrete, mix design for a given weight. The particle size distribution indicates how much surface area is present that will have to be coated with paste, as well as indications of water demand. The absorption rate helps account for water that will be, absorbed from the mix that will not be immediately available for use in the chemical reactions (hydration) of the concrete.

A sample of the rice husks was run through a stack of standard sieves to determine the particle size distribution in accordance with ASTM C136-06 Standard Test Method for Sieve Analysis of Fine and Coarse Aggregates, with the exception of the mass of the sample size. The mass was adjusted to represent approximately the same volume of material used for testing conventional fine aggregates.

The results of the test indicate that, if used as the sole aggregate in a concrete mix, considerable void space would be expected to be present. Workability, pumping, and finishability would all be expected to be negatively affected by a mix containing rice husks as the sole aggregate. Typically gap-graded aggregate profiles are compensated for by the introduction of more paste (that is, cement and water) into the mix in an attempt to fill void spaces.

Typically, determining the specific gravity of the rice husks would involve allowing a fine aggregate to soak in water for 24 hours, and then drying it back to saturated surface dry (SSD) condition using a hair dryer or similar apparatus. A modified approach using a hot plate in place of the hair dryer was used to bring the rice husks to SSD condition, but steps followed otherwise were in accordance with ASTM C128-07 Standard Test Method for Density, Relative Density (Specific Gravity), and Absorption of Fine Aggregate. Three trials were run, with an average result of a bulk specific gravity of 0.07. This result was thought to be abnormally low, so further testing using a vacuum pyncnometer was performed. Results were compared to expected densities of concrete containing the rice husks, and a bulk specific gravity of 0.12 was finally arrived at.

Three absorption trials were run by allowing the rice husks to soak in water for 24 hours, getting them to SSD condition, then drying in an oven at 230° F. for 24 hours. From this, the quantity of absorbed water could be determined. The absorption rate was found to average 110%,

### Example 3

Because the rice husks represented a gap-graded situation when used as the sole aggregate, several mixes were prepared using additional aggregate made up of a fine (approx. 2.2 FM) sand. In total, seven mixes were prepared. The final mix (#7) was prepared in response to the unusually high absorption numbers of the previous six mixes in an attempt to show that the absorption rate could be controlled easily.

The materials used for this project included:

Cement: ASTM C150 Type I/II Buzzi Unicem, Chattanooga, Tenn.

Rice Husks: As supplied

Sand: ASTM C33 Natural Sand, Sand Switch, Dunlap, Tenn.

Water: City, Potable

Admixture: Polyheed 900, BASF Admixtures

Integral Waterproofing: Treat-Proof, Spraylock Concrete Protection, Chattanooga, Tenn.

| | | Rice | | | |
|---|---|---|---|---|---|
| Mix | Cement | Husks | Sand | Water | |
| # | (lbs.) | (lbs.) | (lbs.) | (lbs.) | Other |
| 1 | 900 | 360 | 0 | 918.3 | |
| 2 | 1200 | 160 | 1000 | 918.3 | |
| 3 | 1200 | 39 | 0 | 262.2 | |
| 4 | 1200 | 20 | 1000 | 262.2 | |
| 5 | 1200 | 80 | 500 | 416.5 | +12 oz./cwt Polyheed 900 |
| 6 | 1200 | 103 | 0 | 416.5 | +12 oz./cwt Polyheed 900 |
| 7 | 1200 | 206 | 0 | 416.5 | +12 oz./cwt Polyheed 900 |
| | | | | | & pre-soak in silica solution |

Mix #1 was found to be paste-deficient in that the cement paste did not adequately coat all of the rice husks. In addition, the mix was found to be still relatively plastic at 24 hours, likely due to the high w/c ratio. From this initial mix, a surface area calculation was performed to arrive at a minimum cementitious content needed to coat the grains adequately, and 1200 lbs. of cement was chosen for the remainder of the mix designs. Subsequent hardened concrete testing of mix #1 confirmed suspicions of low cement content with poor performance.

| | | Air | SSD Density | Dry Density |
|---|---|---|---|---|
| | Slump | Content | (lbs./ft.³) | (lbs./ft.³) |
| Mix 1 | 0″ | NA | 75.19 | 45.76 |
| Mix 2 | 2.5″ | 3.50% | 112.00 | 94.14 |
| Mix 3 | 0″ | 3.20% | 130.00 | 113.95 |
| Mix 4 | 0″ | 3.10% | 136.19 | 121.72 |
| Mix 5 | 2.25″ | 3.10% | 109.24 | 88.05 |
| Mix 6 | 2.5″ | 3.10% | 129.53 | 115.00 |
| Mix 7 | 4.0″ | 2.20% | 132.15 | 122.72 |

From the fresh concrete properties shown above, it is apparent is that the rice husk-containing concrete was relatively insensitive to the addition of water and/or water reducing admixtures. Water amounts that normally would have turned a typical concrete mix into a very wet, segregating mess (as in mixes #1 and #2), had relatively little effect on slump. This is likely due to the angle of repose of the rice husks, which causes it to behave much more like a fiber in the fresh concrete state than a fine aggregate.

High strain rates and “flatline” behavior in compression testing indicate a period of energy absorption before failure in compression. This behavior is typically only seen in high percentage fiber-reinforced concrete mixes. This behavior suggests an adjustment to the concrete's modulus of elasticity. Typical strain rates of concrete at maximum compressive strength are around 0.002. Even the lowest strain rates achieved in this example are three times that of normal concrete, with higher strain rates achieved being as much as 35 times that of normal concrete.

### Example 4

### Mix Design Used

| | lbs./yd³ | kg/m³ |
|---|---|---|
| Cement (ASTM C 150 Type I/II): | 1000 | 764.5 |
| Rice Husks | 128 | 97.6 |
| Water | 462 | 353.2 |
| HRWR (ASTM C 494 Type F) | 6 fl. oz./cwt. | 117 mL/100 kg |
| w/c ratio | 0.46 | 0.46 |

### Mixing:

Hobart A-200 industrial Floor Mixer: 7.5 minutes mixing time at 108 RPM

### Samples:

16″×8″×8″ (400 mm×200 mm×200 mm) solid blocks were cast in three layers. Each layer was consolidated by rodding 64 times with a hemispherical-tipped ⅝″ standard tamping rod. Each layer was tapped 10-15 times with a 1.25 lb. rubber mallet.

### Results (English Units):

| | | | | | Avg. | Single |
|---|---|---|---|---|---|---|
| | # of | Single Test | Single Test | Average | Acceptance | Sample |
| Test | Samples | High | Low | Test Result | Value | Acceptance |
| Compressive | 6 | 720 psi | 580 psi | 630 psi | 464 psi | 377 psi |
| Strength | | | | | | |
| Efflorescence | 6 | No | No | No | No | No |
| | | Efflorescence | Efflorescence | Efflorescence | Efflorescence | Efflorescence |
| Thermal | 3 | 5.7 | 5.2 | 5.4 | — | — |
| Conductivity | | | | | | |
| (R value) | | | | | | |
| Reaction to | 6 | 4.05″ | 1.68″ | 3.00″ | Flame | Flame |
| Fire* | | | | | Spread no | Spread no |
| | | | | | more than 6″ | more than 6″ |
| | | | | | in 60 | in 60 |
| | | | | | seconds | seconds |

### Results (SI Units):

| | | | | | Avg. | Single |
|---|---|---|---|---|---|---|
| | # of | Single Test | Single Test | Average | Acceptance | Sample |
| Test | Samples | High | Low | Test Result | Value | Acceptance |
| Compressive | 6 | 5.0 N/mm2 | 4.0 N/mm2 | 4.3 N/mm2 | 3.2 N/mm2 | 2.6 N/mm2 |
| Strength | | | | | | |
| Efflorescence | 6 | No | No | No | No | No |
| | | Efflorescence | Efflorescence | Efflorescence | Efflorescence | Efflorescence |
| Thermal | 3 | 1.0 | 0.9 | 1.0 | — | — |
| Conductivity | | | | | | |
| (RSI value) | | | | | | |
| Reaction to | 6 | 103 mm | 43 mm | 76 mm | Flame | Flame |
| Fire* | | | | | Spread no | Spread no |
| | | | | | more than | more than |
| | | | | | 150 mm in 60 | 150 mm in 60 |
| | | | | | seconds | seconds |

*Note 1: No visible flame was recorded.
Values reported represent the largest diameter of the resulting charred/blackened area from the flame test that indicated combustion.

### Conclusions:

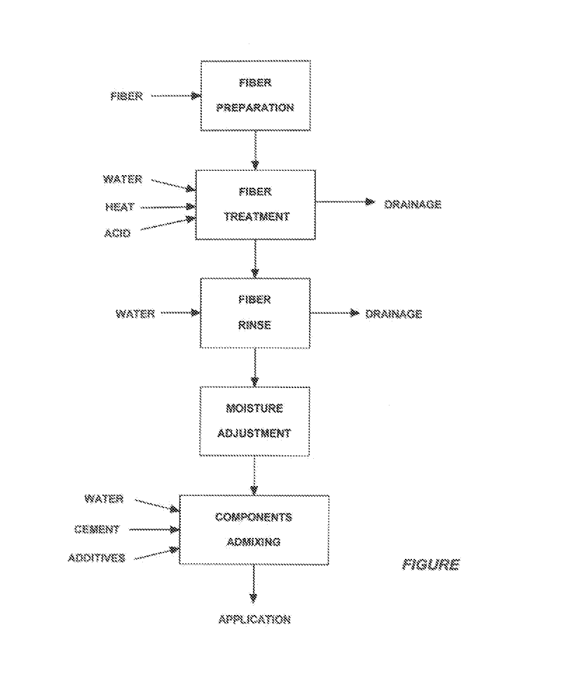

1. Although the reaction to fire test as specified by DMS 17:2006 is typically done on the insulating insert material, it was believed to be beneficial to obtain the values for the rice husk concrete.
2. Absorption testing as required by DMS 17:2006 as well as the remaining required four (4) efflorescence samples to follow at a later date.
3. Thermal conductivity was determined by using a simple insulated calibrated box design, instrumented with thermocouples (see Appendix, FIG. 4). Further thermal conductivity testing should be run by a certified laboratory to verify results.
4. In general, the rice husk concrete's performance in this battery of tests indicates that it may be suitable for use for projects that require compliance with DMS 17:2006. However, the results obtained above represent the results from a single source of rice husks, cement, admixture, and water. As such, they can only be taken as a general indication that the material may meet the required standard. Testing should be repeated with materials specific to production to ensure applicability for a specific project.

### Example 5

A batch of the inventive composition was made using the following:

1) 79 lbs. of 42.5 grade Portland cement.
2) 8 lbs. of processed rice hull fibers.

### 3) 6 oz. of DCI-S

4) 6 gallons of clean mix water

These samples were made in accordance with Redi-Mix industry standards for concrete testing. That is, each sample was poured in 3 lifts, rodding each lift 28 times. Sides were tapped and, in addition, samples were shaken to get excess air out.

Advantageous results in producing the inventive material have been achieved through the use of a twin-shaft mixer to mix the component materials. For example, the Astec twin-shaft mixer, manufactured and sold by Astec Industries of Chattanooga, Tenn., is designed to mix aggregate, admixtures, cementitious materials, and water. The intense mixing action of inter-meshing, timed paddle arms, and shanks produce shearing forces that ensure homogeneity of the combined materials in the shortest practical times.

The mixing paddles and shanks are mounted on the timed driving shafts, in equally spaced rows, opposing each other and counter-rotating during operation. The paddles are positioned in a unique pattern to drive material across and down mixer in a directed travel path over four times the lineal feet of the length of the mixer body.

These paddle positions are located at angles of 90 degrees and 45 degrees from the centerline of the driving shafts, and are installed so that each shaft has alternating rows of 45 degrees paddles in opposition to alternating rows of 90 degrees paddles. This produces a mixing pattern, called serpentine mixing, that simultaneously shears the consolidating constituent materials, drives the material across to the opposing side of the mixer, and pushes the plastic concrete toward the discharge opening of the mixer body.

Combined constituent materials enter the mixer body by means of conveyance through a material inlet water curtain utilizing continuously proportioned water in the required quantity sprayed in such a way to encircle the constituent materials flowing through the material inlet. The water curtain acts as a fugitive cement suppressant while it ensures that all pre-blended materials are lofted, agitated, and showered with precisely metered water.

A technical manual for the Hobart A-200 mixer is readily available, and provides details regarding a suitable twin-shaft mixer for use in carrying out the method of the invention. This manual is incorporated herein in its entirety. It will be appreciated by those of skill in the art that other mixers, similar or different, may be used with good results.

A high shear floor mixer, operated at or about 109 rpm, can approximate the effects of the twin shaft mixer and can be used advantageously in performing the method of the present invention.

The present invention has been described by way of example and in terms of preferred embodiments. However, it is to be understood that the present invention is not strictly limited to the particularly disclosed embodiments. To the contrary, various modifications, as well as similar arrangements, are included within the spirit and scope of the present invention. The scope of the appended claims, therefore, should be accorded the broadest possible interpretation so as to encompass all such modifications and similar arrangements.

What is claimed is:

1. A composition, comprising:
an admixture of at least one cementitious component and at least one cellulosic component;
wherein the at least one cellulosic component includes
at least one cellulosic fibrous material having a length of about 0.1 centimeters to about 2.0 centimeters and an aspect ratio of about 1.0 to about 0.05, and
a first amount of water associated with the at least one cellulosic fibrous material of from about 20 percent to about 40 percent, as measured by weight of water to weight of water and the at least one cellulosic fibrous material combined;
wherein the amount of the at least one cementitious component is included in a range of about nine times to about eleven times by weight compared to the amount of included cellulosic component; and
wherein the admixture is suitable for mixing with a second amount of water to form a hardened material.

2. The composition of claim 1, further comprising a quantity of corrosion inhibitor.

3. The composition of claim 2, wherein the corrosion inhibitor is DCI-S.

4. The composition of claim 1, wherein the cementitious component includes at least one of a mortar, a gravel, a sand, and an accelerant.

5. The composition of claim 1, wherein the cementitious component includes a hydraulic cement.

6. The composition of claim 5, wherein the cementitious component includes a Portland cement.

7. The composition of claim 6, wherein the Portland cement is a 42.5 grade Portland cement.

8. The composition of claim 1, wherein the cellulosic fibrous material is woody plant material.

9. The composition of claim 8, wherein the cellulosic fibrous material is a wood chip.

10. The composition of claim 8, wherein the cellulosic fibrous material is wood pulp.

11. The composition of claim 1, wherein the cellulosic fibrous material is non-woody plant material.

12. The composition of claim 1, wherein the cellulosic fibrous material is bagasse material.

13. The composition of claim 1, wherein the cellulosic fibrous material is a cellulosic hull material.

14. The composition of claim 1, wherein the cellulosic fibrous material is extracted from a cellulosic hull selected from the group consisting of a cotton hull, a grain hull, and a nut hull.

15. The composition of claim 1, wherein the cellulosic hull is a grain hull.

16. The composition of claim 15, wherein the cellulosic hull is a rice hull.

17. The composition of claim 16, wherein the cellulosic fibrous material is processed rice hull fibers.

18. The composition of claim 1, wherein the cellulosic fibrous material has a length in a range of about 0.5 centimeters to about 1.0 centimeters.

19. The composition of claim 1, wherein the cellulosic fibrous material has a particle size distribution with controlled head and tail portions.

20. The composition of claim 1, wherein:
the cementitious component is Portland cement included in a range of about 78 parts to about 80 parts; and
the cellulosic component is rice hull fibers included in a range of about 7 parts to about 9 parts.

21. Allowable material, comprising:
the composition of claim 20, and
the second amount of water, included in a range of about 90 fluid ounces to about 110 fluid ounces per part.

22. A flowable material, comprising:
the composition of claim 1, and
the second amount of water, included in a range of about 90 percent to about 110 percent, as measured by weight of water to weight of cellulosic fibrous material.

23. A hardened material, comprising the composition of claim 1, wherein the hardened product has a compression test value of at least about 2,000 pounds of pressure per square inch.

24. A method, comprising:
reducing a cellulosic fiber material to produce a fiber fragment material;
treating the fiber fragment material, including
admixing the fiber fragment material and a quantity of water to form an admixture, wherein the quantity of water falls in a range of from about 20 percent to about 40 percent, as measured by weight of water to weight of water and the fiber fragment material combined,
heating the admixture,
agitating the admixture, and
separating a treated fiber fragment product from the admixture; and
rinsing the treated fiber fragment product with water to form a rinsed fiber fragment material;
wherein the method is effectively controlled so that the rinsed fiber fragment material is suitable for reacting with a cementitious component to form a hardened material.

25. The method of claim 24, wherein the fiber fragment material has a length of about 0.1 centimeters to about 2.0 centimeters and an aspect ratio of about 1.0 to about 0.05.

26. The method of claim 24, further comprising acid-treating the admixture.

27. The method of claim 24, further comprising:
admixing the rinsed fiber fragment material, a cementitious binder, and water; and
mixing the admixture to produce a mixed mass.

28. The method of claim 27, wherein:
the cementitious binder is Portland cement included in a range of about 78 parts to about 80 parts; and
the cellulosic fiber material is rice hull fibers included in a range of about 7 parts to about 9 parts.

29. The method of claim 28, wherein the water is included in a range of about 90 fluid ounces to about 110 fluid ounces per part.

30. The method of claim 27, wherein mixing the admixture includes mixing the admixture using a twin-shaft mixer.

31. The method of claim 30, further comprising mounting mixing paddles and shanks of the mixer on timed driving shafts in equally-spaced rows, opposing each other and counter-rotating during operation.

32. The method of claim 31, further comprising disposing the mixing paddles at angles of 90 degrees and 45 degrees from a center line of the driving shafts, such that each shaft has alternating rows of 45-degree paddles in opposition to alternating rows of 90-degree paddles.

33. The method of claim 27, further comprising reacting the mixed mass to create a hardened material including reacted rinsed fiber fragment material and the cementitious binder.

34. The method of claim 24, further comprising:
admixing at least one cementitious component and the rinsed fiber fragment material;
wherein the amount of the at least one cementitious component is included in a range of about nine times to about eleven times by weight compared to the amount of included rinsed fiber fragment material; and
wherein the composition is suitable for mixing with a second amount of water to form a hardened material.
